(19) United States
(12) Patent Application Publication
(10) Pub. No.: US 2003/0187543 A1
(43) Pub. Date: Oct. 2, 2003

(54) Bulk material sensor with integral control devices

(76) Inventor: Kevin Moore, Trimont, MN (US)

Correspondence Address: Law Offices of John D. Gugliotta, 202 Delaware Building, 137 South Main Street, Akron, OH, 44308, US

(21) Appl. No.: 10/112,287

(22) Filed: Apr. 1, 2002

(51) Int. Cl. G06F 7/00

(52) U.S. Cl. 700/213

(57) ABSTRACT

A bulk material sensor with integral control devices is provided having a proximity switch combined with power and control devices such as power relays, control relays, and/or timing relays. These components along with necessary interconnecting wiring and terminal blocks are combined in one unified enclosure. The enclosure also provides protection against environmental hazards such as dust, dirt, moisture, vibration, extreme temperature conditions and the like, ensuring a long life span.

### RELATED APPLICATIONS

There are no previously filed, nor currently any co-pending applications, anywhere in the world.

### BACKGROUND OF THE INVENTION

1. Field of the Invention

The present invention relates generally to electrical control devices in industrial applications. More specifically, the present invention relates to an automatic sensing device for use on bulk material handling devices.

2. Description of the Related Art

Proximity type sensors used on industrial bulk material handling systems are currently in existence. They are commonly used to control conveyors, augers, gate operators, and the like on systems from ore mining operations to food processing plants. Whenever a product flow is achieved, is stopped, a level is reached or a blockage occurs, these sensors form the eyes of the automation process, thus allowing the process to adjust to dynamically changing conditions. Often these sensors are used as part of a process system which relies on the use of programmable logic controllers or PLC's. These PLC's can be used to provide increased current carrying capabilities from the typically low level provided by the sensor. They can also provide time delay functions that allow for an operation to begin only after a product movement has been maintained or ceased for a certain period of time. While the PLC greatly increases the functionality of bulk material handling systems, they do require a certain level of knowledge and skill to initially install and program. After they have been in operation for an extended period of time and a change in operating parameters is required, personnel trained in the programming of a PLC must be brought back, at a substantially high labor rate, all for the sake of possible just changing a timing interval.

There is also the condition of many bulk material handling systems that are incredibly small in scale and simple in design, yet require the functionality of increased power handling characteristics, or the functionality of delayed response.

The cost of adding a PLC to provide this functionality is prohibitively expensive. Other methods such as relay cabinets or separate enclosures may also be expensive or impossible depending on installation requirements. Bulk material sensors which provide for increased current capabilities or time delay functions all within an integral enclosure would provide this functionality, but do not currently exist.

A search of the prior art did not disclose any patents that read directly on the claims of the instant invention; however, the following references were considered related.

The following patents disclose a proximity switch control mechanism for a conveyor belt:

U.S. Pat. No. 5,231,919 issued in the name of Lawrence et al.

U.S. Pat. No. 5,027,700 issued in the name of Tschesche.

The following patents describe sample handling apparatus with circulation monitored by proximity switches:

U.S. Pat. No. 4,506,777 issued in the name of Kampf;

U.S. Pat. No. 4,503,964 issued in the name of Kampf et al.

U.S. Pat. No. 6,152,289 issued in the name of Wark et al. discloses a line balance and jam prevention apparatus for parts conveyed between manufacturing stations.

U.S. Pat. No. 6,132,176 issued in the name of Higgins describes a flow control sensor and method for filling a filter press.

U.S. Pat. No. 5,906,262 issued in the name of Miki describes a position control system for a non-contacting magnetic conveyor system.

U.S. Pat. No. 4,736,831 issued in the name of Fields discloses a can unscrambler device controlled by proximity switches.

U.S. Pat. No. 4,265,357 issued in the name of Amberg et al. describes an article infeed gate and proximity switch control therefore.

Consequently, there exists a need for a means by associated power and control devices can be incorporated in a unified enclosure along with sensing devices such as proximity switches for use on industrial type material handling systems.

### SUMMARY OF THE INVENTION

It is therefore an object of the present invention to provide an improved bulk material sensor with integral control devices that are electrically interconnected and located with an environmental enclosure.

It is another object of the present invention to automatically activate and deactivate bulk material handling devices without manual manipulation or user intervention.

It is therefore another object of the present invention to automatically activate and deactivate bulk material handling devices directly without the use of external power control devices such as interposing relays.

It is therefore another object of the present invention to automatically activate and deactivate bulk material handling devices directly without the use of external control devices such as timing relays.

It is a further object of the present invention to provide a device which is protected from environmental hazards such as dust, dirt, moisture, vibration, extreme temperature conditions and the like, ensuring a long life span.

It is another object of the present invention to provide a device that prevents controlled devices such as motors, solenoids, and the like from prematurely starting or stopping, thus preventing excessive wear and tear of said controlled devices.

Briefly described according to one embodiment of the present invention, a bulk material sensor with integral control devices is provided. The invention consists of a sensor, such as a proximity switch, combined with power and control devices such as power relays, control relays, and/or timing relays. These components along with necessary interconnecting wiring and terminal blocks are combined in one unified enclosure. The enclosure also provides protection against environmental hazards such as dust, dirt, moisture, vibration, extreme temperature conditions and the like, ensuring a long life span. The invention is intended to provide supplemental operating features to material handling control systems with a minimal impact of external devices or control system reconfiguration.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is an electrical schematic of an embodiment of the bulk material sensor with integral control devices which incorporates a power handling relay;

FIG. 2 is an electrical schematic of an embodiment of the bulk material sensor with integral control devices which incorporates a timing relay;

FIG. 3 is an electrical schematic of an embodiment of the bulk material sensor with integral control devices which incorporates dual timing relays;

FIG. 4 is an isometric view of the bulk material sensor with integral control devices;

FIG. 5 is an interior view of the bulk material sensor with integral control devices which incorporates a power handling relay;

FIG. 6 is an interior view of the bulk material sensor with integral control devices which incorporates an eight-pin plug-in timing relay;

FIG. 7 is an interior view of the bulk material sensor with integral control devices which incorporates a din-rail mount timing relay; and

FIG. 8 is an interior view of the bulk material sensor with integral control devices which incorporates dual eight-pin plug-in timing relays.

### DESCRIPTION OF THE PREFERRED EMBODIMENTS

The best mode for carrying out the invention is presented in terms of its preferred embodiment, herein depicted within the Figures.

1. Detailed Description of the Figures

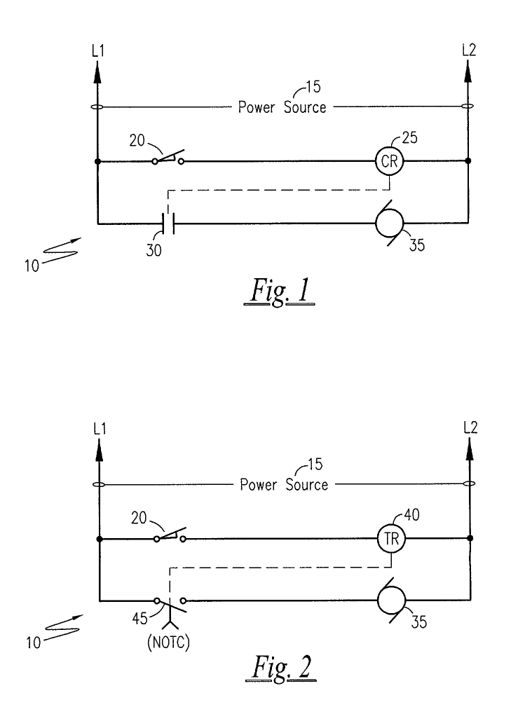

Referring now to FIG. 1, an electrical schematic of an embodiment of a bulk material sensor with integral control devices 10 incorporating a power handling relay is disclosed. The circuit receives power from a power source 15.

The power source 15 is envisioned to be any type of common supply of typical voltage and associated current level, such as 120 VAC, 240 VAC, 480 VAC, 24 VAC, 12 VDC or the like, and protected from short circuit and overload conditions. The balance of the components used in the circuit would be rated to handle the said power rating along with wiring and connecting means. As the power source 15 used is not a function of the present invention, it is simply referred to as a power source for the balance of this, and all remaining FIGS. A proximity switch contact closure 20 provides a switching means to route electrical power to a control relay coil 25. The proximity switch contact closure 20 is envisioned to be a dry contact closure from any type of proximity switch such as a photoelectric eye, a limit switch, a capacitance proximity switch, a radioactive level switch, or any type of sensing device that can generate a contact closure in response to a changing physical condition. Upon energization of the control relay coil 25, an instantaneous contact closure 30 is closed via a magnetic mechanical action path defined by a dotted line. The instantaneous contact closure 30 is capable of much higher current and associated power levels envisioned to be 30 amperes or more. Once closed, a circuit path to an electrical load 35 such as a motor, a solenoid or the like is closed, and said electrical load 35 operates.

Referring now to FIG. 2, an electrical schematic of the bulk material sensor with integral control devices utilizing a timing relay is disclosed. The power source 15 and the proximity switch contact closure 20 operate in an identical manner to that described in FIG. 1. However, in lieu of the control relay coil 25 being activated as shown in FIG. 1, a timing relay coil 40 is energized instead. The timing relay coil 40, through a magnetic mechanical action path defined by a dotted line, activates a timing relay contact 45. The timing relay coil 40 and timing relay contact 45 relationship can be a pneumatic time delay, an electronic time delay or any method of suitably delaying an action of the timing relay contact 45 upon energization or deenergization of the timing relay coil 40. As before, the increased current carrying capabilities of the timing relay contact 45 allow for operation of the electrical load 35. The timing relay contact 45, as disclosed in FIG. 2 is a “normally open- timed close” contact, meaning that the timing relay contact 45 is normally open and will remain open, even after the energization of the timing relay coil 40 for a predetermined time period. This operation mode is envisioned as being advantageous in those instances where a

product flow must be maintained, or a level must be verified before an operation begins. This eliminates false starting of the electrical load 35 on sporadic operations of the proximity switch contact closure 20. However, other configurations such as those afforded by “on-delay” and “off-delay” relays coupled with normally open and normally closed contact configurations yield a multitude of options which are selectable and modifiable at the point of use.

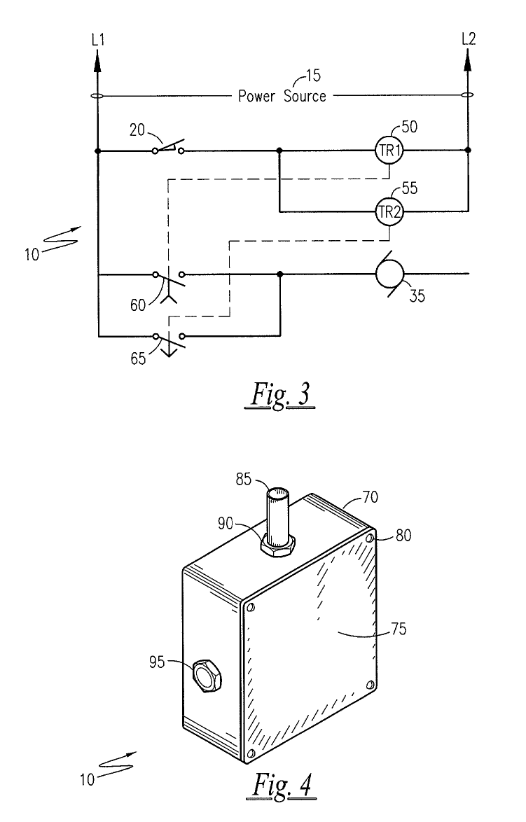

Referring next to FIG. 3, an electrical schematic of the bulk material sensor with dual timing relays is disclosed. The power source 15 and the proximity switch contact closure 20 operate in an identical manner to that described in FIG. 1. However, in lieu of one coil, there are two. The closure of the proximity switch contact closure 20 operate a timing relay coil one 50 and a timing relay coil two 55, which are wired in parallel. The timing relay coil one 50 operates a timing relay contact one 60, through a magnetic mechanical action path defined by a dotted line. The timing relay coil two 55 operates a timing relay contact two 65, through a separate magnetic mechanical action path defined by a separate dotted line. The timing relay contact one 60 and the timing relay contact two 65 are wired in parallel and feed the electrical load 35 in a series configuration. In such an arrangement, the timing relay contact one 60 and/or the timing relay contact two 65 can operate the electrical load 35. While many operating configurations are possible and field selectable by the user, such wiring would be appropriate in those instances where material flow must be maintained for a certain time limit before operation of the electrical load 35 can begin and must continue operation for a certain time limit after the material flow has stopped. The bulk material sensor with integral control devices 10 allows all parameters of operation configuration and time delays to be configured and set at the bulk material sensor with integral control devices 10 at the sensing site.

Referring now to FIG. 4, an isometric view of the bulk material sensor with integral control devices 10 is depicted. The bulk material sensor with integral control devices 10 is enclosed in an environmental enclosure 70 made of steel, plastic or other synthetic material. The environmental enclosure 70 is envisioned to be equivalent of a NEMA 4X enclosure commonly used in industrial environments, though other configurations such as NEMA 1, NEMA 3R, NEMA 4, and/or NEMA 12 are also envisioned, depending on the operating environment said bulk material sensor with integral control devices 10 is installed. Access to internal components for wiring and parameter setting is provided by an access cover plate 75, held captive by a plurality of fastening means 80, such as screws. The sensing device 85 is located on the top of the environmental enclosure 70 and is held in place by a retaining means 90 such as washers, hubs, lock nuts or the like. A conductor retaining fitting 95 is mounted on one side of the environmental enclosure 70 as shown. The conductor retaining fitting 95 is envisioned as being suitable for electrical conduit connection, flexible cord connection or other similar and acceptable wiring method. Configuration of the bulk material sensor with integral control devices 10 is for descriptive purposes only and orientation and size may be governed by physical limitations. The sensing device 85 on the bulk material sensor with integral control devices 10 would be placed in proximity to the bulk material being sensed.

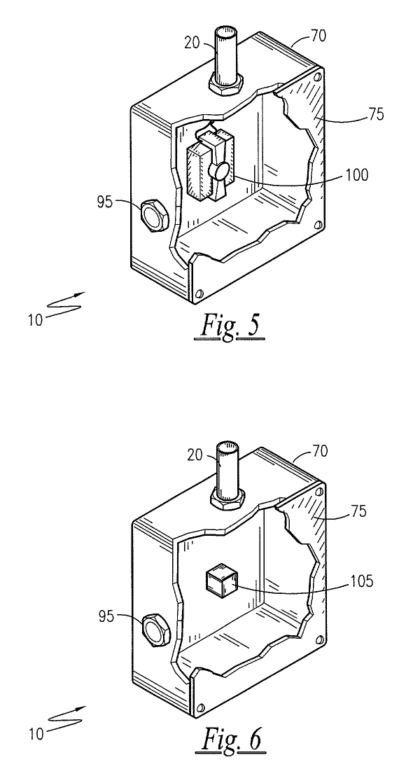

Referring next to FIG. 5, an interior view of the bulk material sensor with integral control devices 10 according to the embodiment which uses a power handling contactor 100 is depicted. The power handling contactor 100, mounted on the interior of the environmental enclosure 70 is visible though a cutaway view of the access cover plate 75. In this manner internal wiring from the proximity switch contact closure 20 and the conductor retaining fitting 95 may be interconnected with the power handling contactor 100 as disclosed in FIG. 1.

Referring now to FIG. 6, an interior view of the bulk material sensor with integral control devices 10 according to the embodiment which uses an eight-pin plug-in relay 105 is depicted. The eight-pin plug-in relay 105, mounted on the interior of the environmental enclosure 70 is visible though a cutaway view of the access cover plate 75. In this manner internal wiring from the proximity switch contact closure 20 and. the conductor retaining fitting 95 may be interconnected with the eight-pin plug-in relay 105 as disclosed in FIG. 2. The eight-pin plug-in relay 105 is a standard industrial component and thus is readily available for use to serve in the functionality as discussed with FIG. 2.

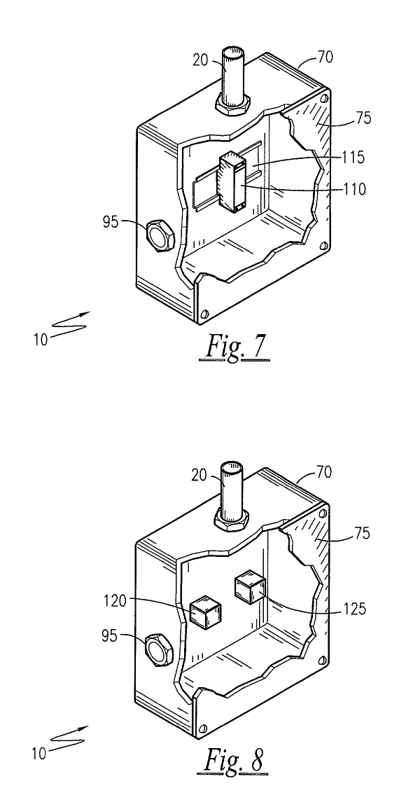

Referring now to FIG. 7, an interior view of the bulk material sensor with integral control devices 10 according to the embodiment which uses a DIN-mounted timing relay 110 is depicted. The DIN-mounted timing relay 110 is mounted on a DIN rail 115 as shown to the rear of the environmental enclosure 70. Both the DIN-mounted timing relay 110 and the DIN rail 115 are visible though a cutaway view of the access cover plate 75. In this manner internal wiring from the proximity switch contact closure 20 and the conductor retaining fitting 95 may be interconnected with the DIN-mounted timing relay 110 as disclosed in FIG. 2. The DIN-mounted timing relay 110, in combination with the DIN rail 115, are standard industrial components and thus are readily available for use to serve in the functionality as discussed with FIG. 2. The DIN rail 115 allows rapid mounting and de-mounting of the DIN-mounted timing relay 110 and the mounting of other DIN-mounted electrical control components.

Referring finally to FIG. 8, an interior view of the bulk material sensor with integral control devices 10 according to the embodiment which uses two timing relays is disclosed. A first timing relay 120 and a second timing relay 125 are mounted on the interior of the environmental enclosure 70 and are visible though a cutaway view of the access cover plate 75. In this manner internal wiring from the proximity switch contact closure 20 and the conductor retaining fitting 95 may be interconnected with the first timing relay 120 and the second timing relay 125 as disclosed in FIG. 3.

2. Operation of the Preferred Embodiment

The present invention is designed with ease of operation features in mind that allow it to be installed and utilized by a common individual with little training. After use of the present invention is dictated by an industrial process system that needs to perform power or control switching based upon dynamic process conditions, the user would determine the correct embodiment of the bulk material sensor with integral control devices 10 to use. For power switching applications, the embodiment as depicted in FIGS. 1 and 5 would be utilized. For control and timing applications, variations of the embodiments as shown in FIGS. 2, 3, 6, 7, and/or 8 would be used. The bulk material sensor with integral control devices 10 leads to direct use in those applications where an existing electrical control system is not present or those applications where an extremely complicated control system already exists and it is too difficult and/or expensive to modify.

The selected bulk material sensor with integral control devices 10 is then installed according to industry standards and regulations. After installation and selection of timing intervals and operations as described in FIGS. 1, 2 and 3, the bulk material sensor with integral control devices 10 is ready to be utilized to perform automatic starting and stopping of prime movers on automated bulk material handling systems

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents. Therefore, the scope of the invention is to be limited only by the following claims.

What is claimed is:

1. A bulk material sensor with integral control devices comprising:
power source;
a first control relay coil;
a proximity switch contact closure for providing a switching means to route electrical power to said first control relay coil such that upon energization of said control relay coil an instantaneous contact closure is closed via a magnetic mechanical action path such that once closed, a circuit path to an electrical load operates;
wherein said power source, said first control relay coil, and said proximity switch contact closure are all enclosed and housed in an environmental enclosure made of a material selected from the group comprising steel and plastic.

2. A bulk material sensor with integral control devices comprising:
power source;
a timing relay coil having a “normally open- timed close” contact, a timing relay contact for providing a switching means to route electrical power to said timing relay coil such that upon energization of said timing relay coil an instantaneous contact closure is closed via a magnetic mechanical action path such that once closed, a circuit path to an electrical load operates;
wherein said power source, said timing relay coil, and said timing relay contact closure are all enclosed and housed in an environmental enclosure made of a material selected from the group comprising steel and plastic

3. The bulk material sensor with integral control devices of claim 1, wherein said power source is of a type of common supply of typical voltage and associated current level comprising 120 VAC, 240 VAC, 480 VAC, 24 VAC, 12 VDC or the like, and protected from short circuit and overload conditions.

4. The bulk material sensor with integral control devices of claim 1, wherein said proximity switch contact closure is a dry contact closure selected from a group comprising photoelectric eye, a limit switch, a capacitance proximity switch, a radioactive level switch, or any type of sensing device that can generate a contact closure in response to a changing physical condition.

5. The bulk material sensor with integral control devices of claim 1, wherein said instantaneous contact closure is capable of current and associated power levels equal to or greater than 30 amperes.

6. The bulk material sensor with integral control devices of claim 2, wherein said timing relay coil and timing relay contact combination is selected from the group comprising a pneumatic time delay and an electronic time delay

7. The bulk material sensor with integral control devices of claim 1, further comprising a second control relay coil electrically controlled in parallel with said first control relay coil operates a timing relay contact two through a magnetic mechanical action.

8. The bulk material sensor with integral control devices of claim 1, wherein said environmental enclosure has a closure rating selected from the group comprising NEMA 1, NEMA3R, NEMA4, NEMA4X and NEMA 12.

9. The bulk material sensor with integral control devices of claim 1, further comprising a power handling contactor mounted on an interior of said environmental enclosure.
